(19) United States
(12) Patent Application Publication
(10) Pub. No.: US 2016/0153282 A1
(43) Pub. Date: Jun. 2, 2016

(54) Stress Reduction For Film Cooled Gas Turbine Engine Component

(71) Applicant: UNITED TECHNOLOGIES CORPORATION, HARTFORD, CT (US)

(72) Inventor: Brandon W Spangler, Vernon, CT (US)

(21) Appl. No.: 14/707,409

(22) Filed: May 8, 2015

Related U.S. Application Data
(60) Provisional application No. 62/023,320, filed on Jul. 11, 2014.

(51) Int. Cl. F01D 5/18; F01D 11/08; F01D 25/12; F01D 9/04

(52) U.S. Cl. CPC F01D 5/186; F01D 9/041; F01D 11/08; F01D 25/12; F05D 2220/32; F05D 2240/121; F05D 2240/303; F05D 2240/55; F05D 2260/202; F05D 2300/131; F05D 2300/20; F05D 2300/5024; F05D 2240/122; F05D 2240/304

(57) ABSTRACT

A component for a gas turbine engine includes a highly conductive film cooled component with a leading edge area and a trailing edge area, the leading edge area including a multiple of film holes spaced to reduce a thermal gradient between the leading edge area and the trailing edge area to below about 200 F (93 C).

### CROSS REFERENCE TO RELATED APPLICATION

This application claims the benefit of provisional application Ser. No. 62/023,320, filed Jul. 11, 2014.

### STATEMENT REGARDING FEDERALLY SPONSORED RESEARCH OR DEVELOPMENT

This disclosure was made with Government support under FA8650-09-D-2923-0021 awarded by The United States Air Force. The Government has certain rights in this disclosure.

### BACKGROUND

The present disclosure relates to components for a gas turbine engine, and more particularly, to cooled gas turbine engine components.

Gas turbine engines typically include a compressor section to pressurize airflow, a combustor section to burn a hydrocarbon fuel in the presence of the pressurized air, and a turbine section to extract energy from the resultant combustion gases. Gas path components are often cooled via external film cooling, internal air impingement, and forced convection, either separately, or in combination. Forced convection cooling refers to compressor bleed air that flows into the turbine section components to continuously remove thermal energy. Film cooling refers to the discharge of compressor bleed air from the turbine section components through a plurality of small film holes to provide a thin, cool barrier along the external surface to prevent or reduce direct contact with the hot combustion core gasses.

Although film cooling has proven effective for cooling of hot section airfoil components, increased temperate engine operations has required the introduction of relatively brittle materials such as Molybdenum and Monolithic ceramics that have operational temperatures of about 2700 F (1480 C) to replace Nickel Superalloys that have operational temperatures of about 2200 F (1200 C). Although effective, such relatively more brittle materials have a relatively lower stress capability than Nickel Superalloys.

### SUMMARY

A component for a gas turbine engine according to one disclosed non-limiting embodiment of the present disclosure includes a highly conductive film cooled component with a leading edge area and a trailing edge area, including a multiple of film holes in a film hole region, each of the multiple of film holes spaced one to another to reduce a thermal gradient aft of the film hole region to below about 200 F (93 C).

A further embodiment of the present disclosure includes, wherein the component is manufactured of Molybdenum.

A further embodiment of any of the foregoing embodiments of the present disclosure includes, wherein the highly conductive film cooled component is manufactured of a Monolithic ceramic.

A further embodiment of any of the foregoing embodiments of the present disclosure includes, wherein the leading edge area and the trailing edge area define a chord of an airfoil.

A further embodiment of any of the foregoing embodiments of the present disclosure includes, wherein the multiple of film holes are arranged in a row transverse to the chord.

A further embodiment of any of the foregoing embodiments of the present disclosure includes, wherein the multiple of film holes provide a coverage of between about 15%-75%.

A further embodiment of any of the foregoing embodiments of the present disclosure includes, wherein the multiple of film holes provide a coverage of between about 40%-60%.

A further embodiment of any of the foregoing embodiments of the present disclosure includes, wherein the multiple of film holes provide a ligament distance greater than about 0.050 in (1.27 mm).

A further embodiment of any of the foregoing embodiments of the present disclosure includes, wherein each of the multiple of film holes define a pitch to diameter (P/D) ratio greater than about 2.2.

A further embodiment of any of the foregoing embodiments of the present disclosure includes, wherein each of the multiple of film holes define a pitch to diameter (P/D) ratio greater than about 4.

A component for a gas turbine engine according to another disclosed non-limiting embodiment of the present disclosure includes a highly conductive film cooled component with a thermal conductivity greater than about 150 BTU (IT)-inch/hour/square foot/° F. and a row of multiple film holes that provide a coverage between about 15%-75%

A further embodiment of any of the foregoing embodiments of the present disclosure includes, wherein the multiple of film holes provide a coverage of between about 40%-60%.

A further embodiment of any of the foregoing embodiments of the present disclosure includes, wherein the multiple of film holes provide a ligament distance greater than about 0.050 in (1.27 mm).

A further embodiment of any of the foregoing embodiments of the present disclosure includes, wherein each of the multiple of film holes define a pitch to diameter (P/D) ratio greater than about 2.2.

A further embodiment of any of the foregoing embodiments of the present disclosure includes, wherein each of the multiple of film holes define a pitch to diameter (P/D) ratio greater than about 4.

A further embodiment of any of the foregoing embodiments of the present disclosure includes, wherein the multiple of film holes reduces a thermal gradient between a film hole region with the of multiple film holes and a trailing edge area aft thereof to below about 200 F (93 C).

A method of cooling a film cooled component for a gas turbine engine, according to another disclosed non-limiting embodiment of the present disclosure includes arranging at least one row of a multiple of film holes proximate a leading edge area of a highly conductive film cooled component to control a thermal gradient aft of the multiple of film holes such that a stress from the thermal gradient is below a predetermined acceptable stress.

A further embodiment of any of the foregoing embodiments of the present disclosure includes, wherein the thermal gradient is below about 200 F (93 C).

A further embodiment of any of the foregoing embodiments of the present disclosure includes, wherein the arranging further comprises providing a ligament distance between each of the multiple of film holes with respect to a thermal conductivity of a material of the highly conductive film cooled component.

A further embodiment of any of the foregoing embodiments of the present disclosure includes, wherein the thermal conductivity of the material is at least about 300% that of a nickel superalloy.

The foregoing features and elements may be combined in various combinations without exclusivity, unless expressly indicated otherwise. These features and elements as well as the operation thereof will become more apparent in light of the following description and the accompanying drawings. It should be understood, however, the following description and drawings are intended to be exemplary in nature and non-limiting.

### BRIEF DESCRIPTION OF THE DRAWINGS

Various features will become apparent to those skilled in the art from the following detailed description of the disclosed non-limiting embodiment. The drawings that accompany the detailed description can be briefly described as follows:

FIG. 1 is a schematic cross-section of an example gas turbine engine architecture;

FIG. 2 is a schematic cross-section of another example gas turbine engine architecture;

FIG. 3 is an enlarged schematic cross-section of an engine turbine section;

FIG. 4 is an exploded view of rotor assembly with a single representative highly conductive film cooled component;

FIG. 5 is a schematic representation of an arrangement of film holes in a portion of highly conductive film cooled component;

FIG. 6 is a schematic representation of an arrangement of film holes;

FIG. 7 is cross-section through one film hole;

FIG. 8 is a graphical representation of effectiveness vs. distance from a film hole;

FIG. 9 is an graphical representation of a stress capability vs. metal temperature;

FIG. 10 is a schematic representation of a film hole relationship for a highly conductive film cooled component according to one disclosed non-limiting embodiment;

FIG. 11 is a RELATED ART schematic representation of a tight film hole relationship for a film cooled component manufactured of a nickel alloy;

FIG. 12 is a schematic representation of a loose film hole relationship for a film cooled component a film cooled component manufactured of a nickel alloy with a film hole relationship according to one disclosed non-limiting embodiment that provides an unacceptable local gradient;

FIG. 13 is a schematic representation of a tight film hole relationship for a highly conductive film cooled component in which the tight film hole relationship results in an overcooled region; and

FIG. 14 is a schematic representation of a film hole relationship for a highly conductive film cooled component according to one disclosed non-limiting embodiment with an acceptable thermal gradient.

### DETAILED DESCRIPTION

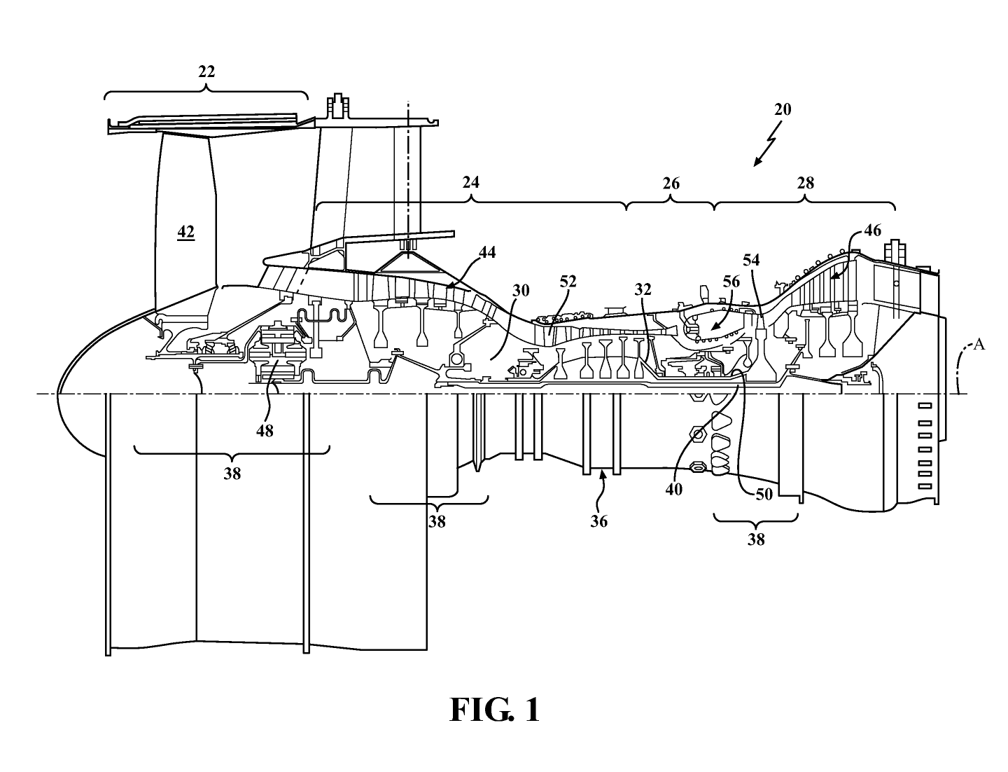

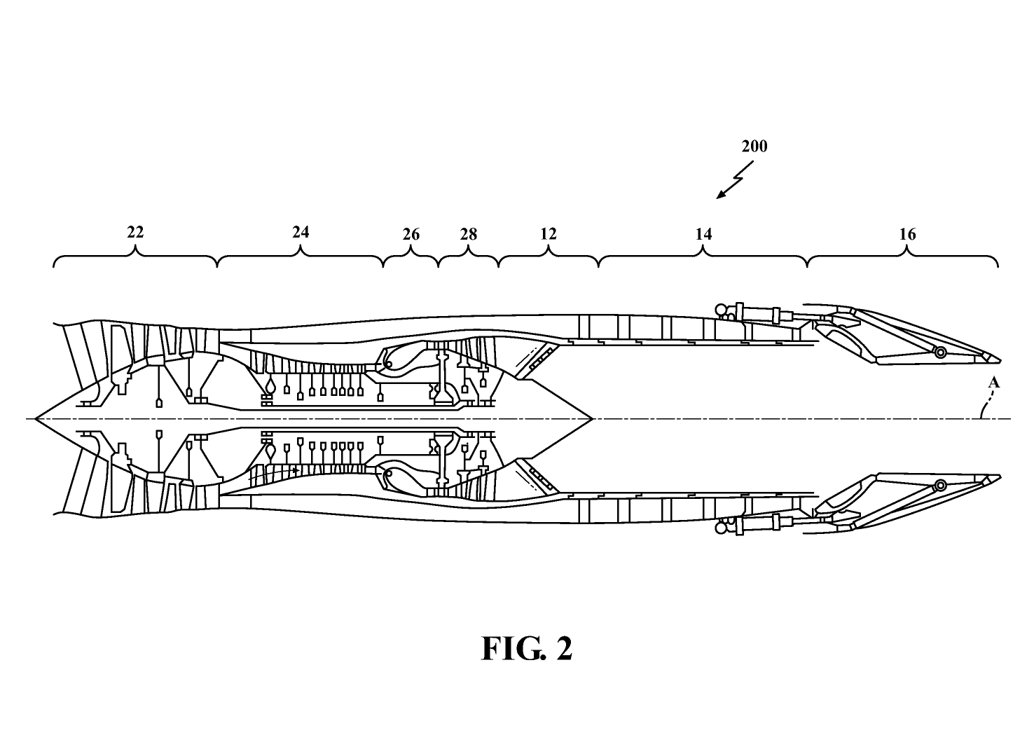

FIG. 1 schematically illustrates a gas turbine engine 20. The gas turbine engine 20 is disclosed herein as a two-spool turbofan that generally incorporates a fan section 22, a compressor section 24, a combustor section 26 and a turbine section 28. Alternative engine architectures 200 might include an augmentor section 12, an exhaust duct section 14 and a nozzle section 16 (FIG. 2) among other systems or features. The fan section 22 drives air along a bypass flowpath while the compressor section 24 drives air along a core flowpath for compression and communication into the combustor section 26 then expansion through the turbine section 28. Although depicted as a turbofan in the disclosed non-limiting embodiment, it should be appreciated that the concepts described herein are not limited to use with turbofans as the teachings may be applied to other types of turbine engine architectures such as turbojets, turboshafts, and three-spool (plus fan) turbofans.

The engine 20 generally includes a low spool 30 and a high spool 32 mounted for rotation about an engine central longitudinal axis A relative to an engine case structure 36 via several bearing compartments 38. The low spool 30 generally includes an inner shaft 40 that interconnects a fan 42, a low pressure compressor (“LPC”) 44 and a low pressure turbine (“LPT”) 46. The inner shaft 40 drives the fan 42 directly or through a geared architecture 48 to drive the fan 42 at a lower speed than the low spool 30. An exemplary reduction transmission is an epicyclic transmission, namely a planetary or star gear system.

The high spool 32 includes an outer shaft 50 that interconnects a high pressure compressor (“HPC”) 52 and high pressure turbine (“HPT”) 54. A combustor 56 is arranged between the HPC 52 and the HPT 54. The inner shaft 40 and the outer shaft 50 are concentric and rotate about the engine central longitudinal axis A which is collinear with their longitudinal axes.

Core airflow is compressed by the LPC 44 then the HPC 52, mixed with the fuel and burned in the combustor 56, then expanded over the HPT 54 and the LPT 46, which rotationally drive the respective low spool 30 and high spool 32 in response to the expansion. The main engine shafts 40, 50 are supported at a plurality of points by bearing compartments 38 within the engine case structure 36.

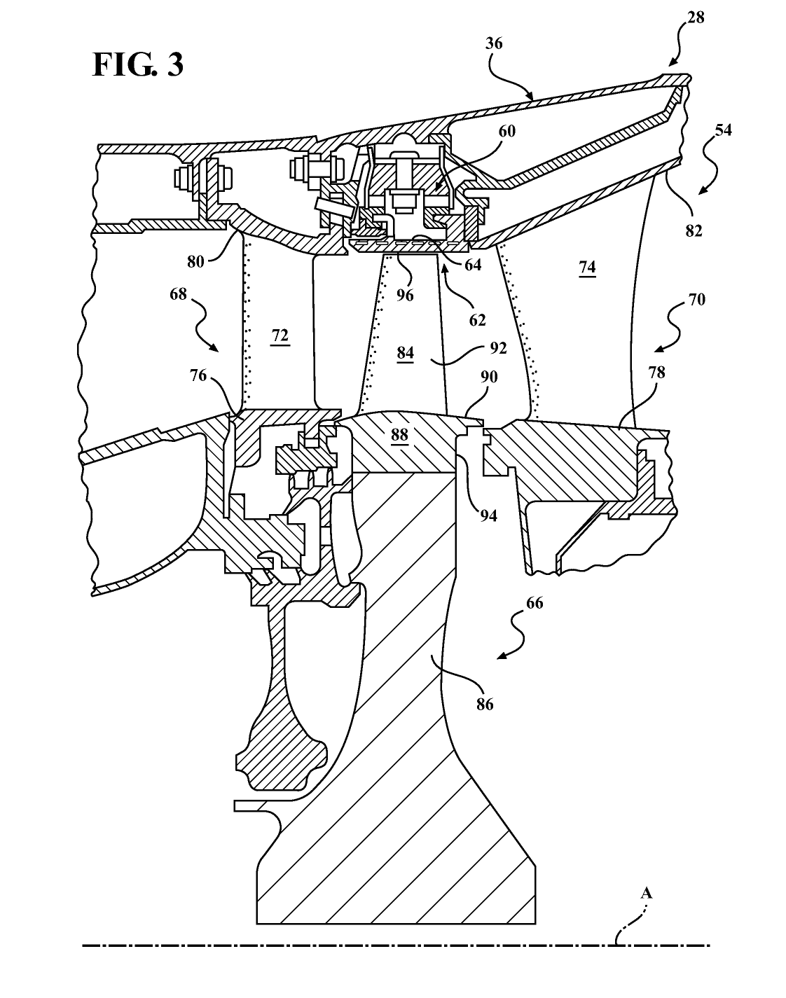

With reference to FIG. 3, an enlarged schematic view of a portion of the HPT 54 is shown by way of example; however, other engine sections will also benefit herefrom. A full ring shroud assembly 60 mounted to the engine case structure 36 supports a Blade Outer Air Seal (BOAS) assembly 62 with a multiple of circumferentially distributed BOAS 64 proximate to a rotor assembly 66 (one schematically shown).

The full ring shroud assembly 60 and the BOAS assembly 62 are axially disposed between a forward stationary vane ring 68 and an aft stationary vane ring 70. Each vane ring 68, 70 includes an array of vanes 72, 74 that extend between a respective inner vane platform 76, 78, and an outer vane platform 80, 82. The outer vane platforms 80, 82 are attached to the engine case structure 36.

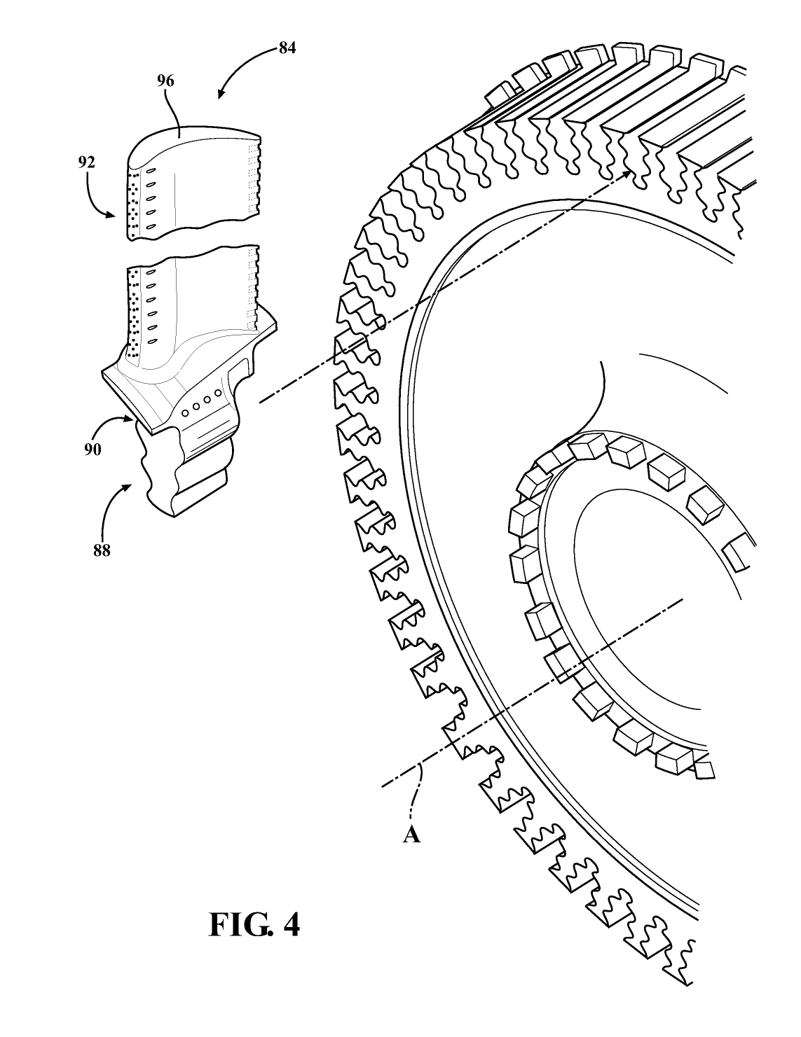

The rotor assembly 66 includes an array of blades 84 circumferentially disposed around a disk 86. Each blade 84 includes a root 88, a platform 90 and an airfoil 92 (also shown in FIG. 4). The blade roots 88 are received within a rim 94 of the disk 86 and the airfoils 92 extend radially outward such that a tip 96 of each airfoil 92 is adjacent to the blade outer air seal (BOAS) assembly 62. The platform 90 separates a gas path side inclusive of the airfoil 92 and a non-gas path side inclusive of the root 88.

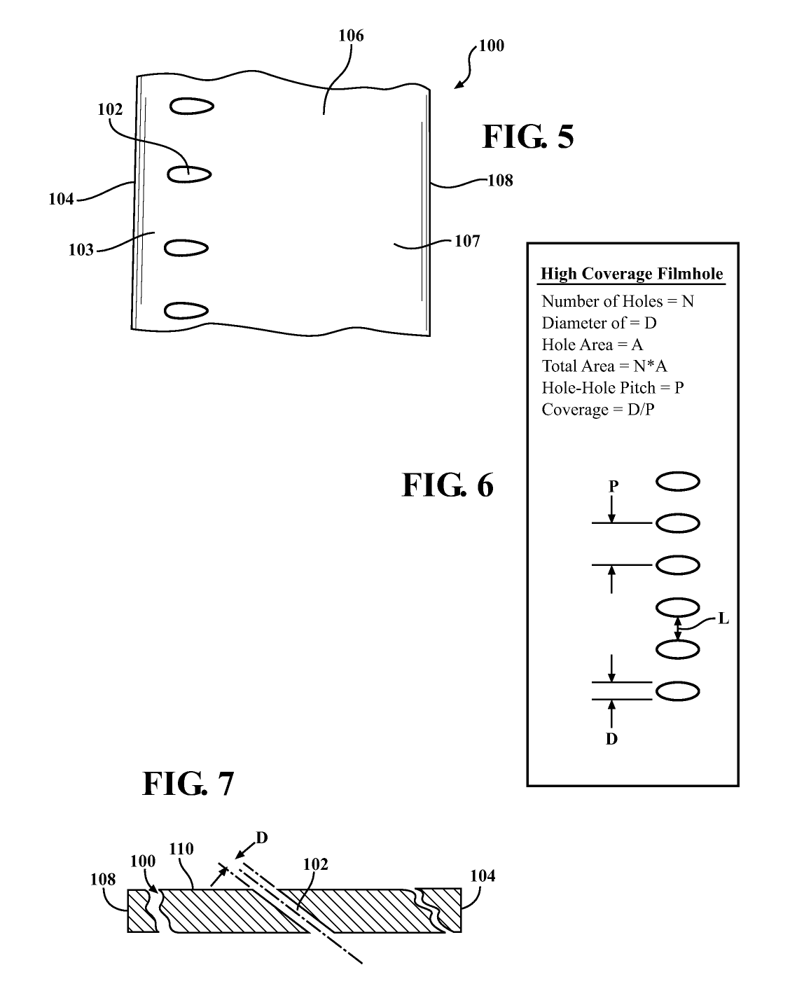

With reference to FIG. 5, a representative portion of a film cooled component 100 such as the BOAS 64, the vanes 72, 74 and/or the blades 84 shown in FIGS. 3 and 4, or other such component includes numerous film holes 102. It should be appreciated that the BOAS 64, the vanes 72, 74, and the blades 84, are merely examples, and that any film cooled component 100 manufactured of a highly conductive material such as Molybdenum, Monolithic Ceramics, etc. will benefit herefrom. That is, the highly conductive film cooled component 100 has a relatively high thermal conductivity as compared to nickel superalloys. In one example, the highly conductive film cooled component 100 has a thermal conductivity that is about 300% that of an equivalent component manufactured of nickel superalloys which has an about 150 BTU (IT)-inch/hour/square foot/° F. thermal conductivity.

In this example, the film holes 102 are located adjacent to a leading edge area 104 of an airfoil 106. The leading edge area 104 is spaced from a trailing edge area 108 to define the chord of the airfoil 106. The film holes 102 are typically arranged in rows along the span of the airfoil 106 transverse to the chord. The rows may be located along the pressure side, the suction side, on the leading edge area 104, and combinations thereof. Further, it should be appreciated that the film holes 102 need not be exactly in-line with one another to constitute a “row”.

With reference to FIG. 6, the film holes 102 within the row may be defined by a number “N” of film holes 102, a diameter “D” of each film hole (FIG. 7), an area “A” of each film hole 102, a pitch (adjacent center to center distance of the film holes 102) “P”, and a ligament distance “L” between adjacent film hole edges. It should be appreciated that, in this embodiment, the film holes 102 are formed by passages that are circular in cross-section and are angled (FIG. 7) with respect to an outer surface 110 of the film cooled component 100 such that the exit of the film hole 102 is typically generally elliptical shaped at the surface 110. However, other shapes and angles will benefit herefrom. The total area of the film holes 102 is the number “N,” multiplied by the area of each hole “A”:N*π*D̂2/4. The coverage of the film holes 102 is the diameter “D” of each film hole 102 divided by the pitch “P”: D/P.

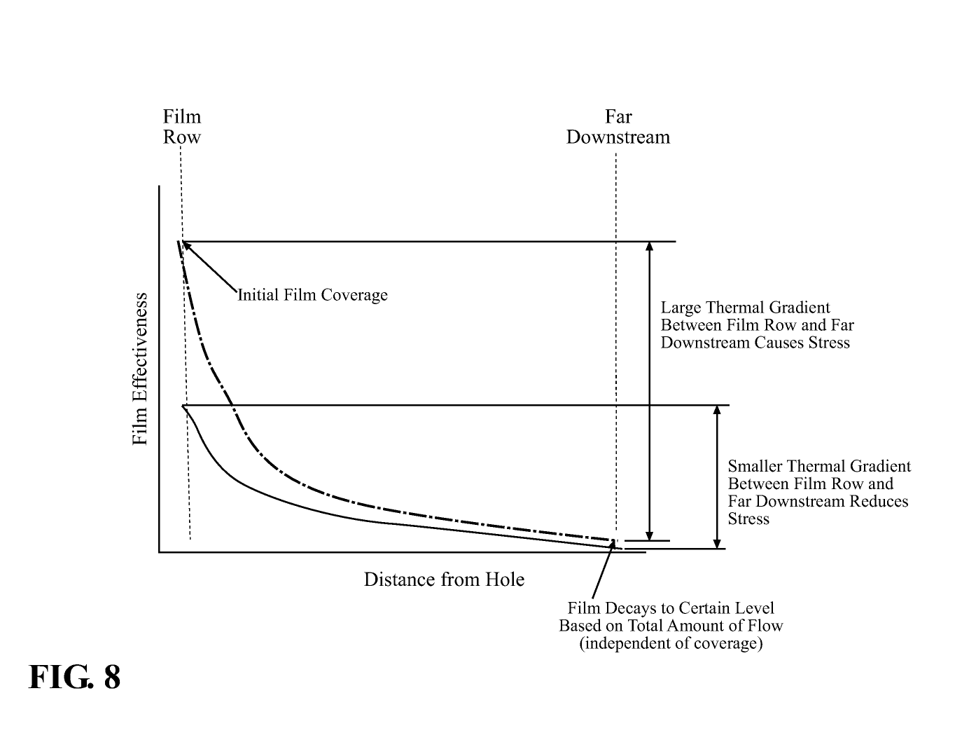

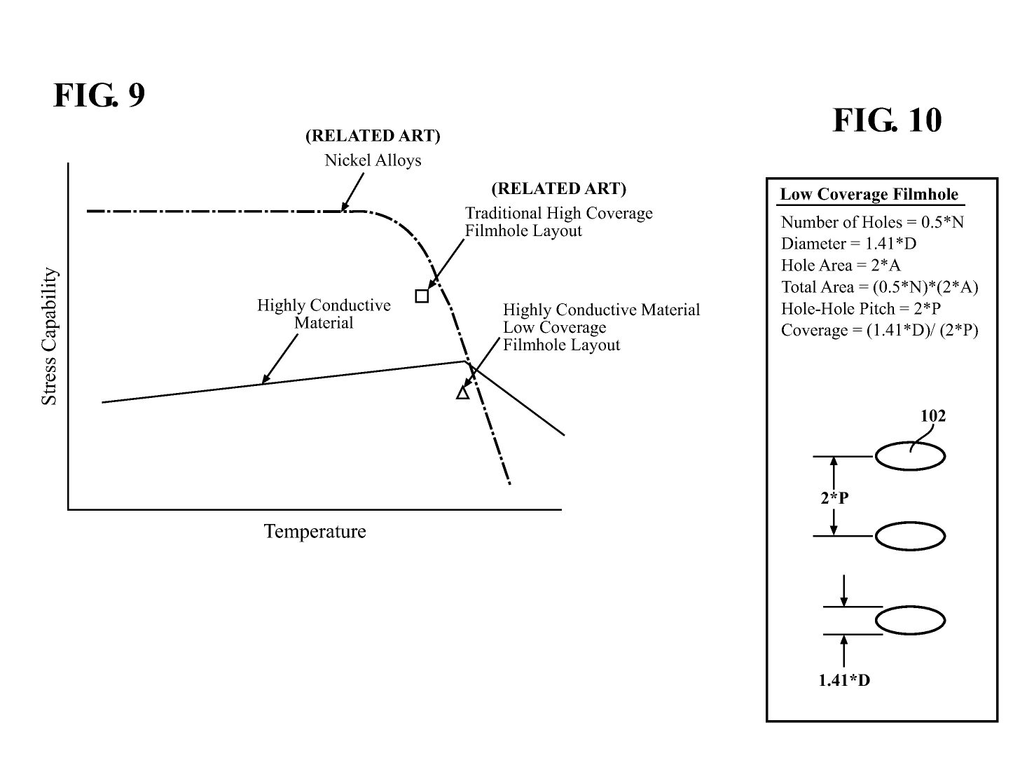

Traditional film hole layouts conventionally utilized in nickel superalloy components generally maximize the number “N” of small area “A” film holes that are pitched “P” close together. The film holes 102 are sized to utilize a minimal quantity of cooling air to minimize impact upon engine efficiency. Although effective at cooling the part, film hole layouts for nickel superalloys result in a relatively large thermal gradient, typically greater than 200 F (93 C) between the area 103 near the film hole 102 and the area 107 far downstream of the film hole 102 (FIG. 8). This thermal gradient generates a stress within the component that is accommodated by the nickel superalloy materials, but is higher than the stress capability of relatively more brittle materials such as film cooled component 100 (FIG. 9).

The thermal gradients are caused by high cooling effectiveness near the film holes 102 and lower cooling effectiveness downstream of the film holes 102 such as toward the trailing edge area 108. The high cooling effectiveness near the film holes 102 is primarily a function of the spacing of the film holes 102 while the cooling effectiveness farther downstream from the film holes 102 is primarily a function of the cooling flow level regardless of the film hole 102 spacing (FIG. 9). As such, the application of traditional film hole layouts conventionally utilized in nickel superalloys to a highly conductive film cooled component 100 manufactured of highly conductive materials results in over cooling of the area 103 proximate the film holes 102 and undesirable thermal gradients.

In order to reduce the thermal gradients that cause stress, the film holes 102 in the highly conductive film cooled component 100 are spaced farther apart in pitch “P” to reduce the cooling effectiveness proximate the film holes 102. The area A of each film hole 102 is also increased to maintain overall cooling flow (FIG. 10).

In one disclosed non-limiting embodiment, the film holes 102 are spaced to reduce thermal gradients below about 200 F (93 C) between the area 103 near the filmholes and the area 107 far downstream of the filmholes to maintain the thermal gradients that generate the stress to that which is within the capability of the relatively more brittle highly conductive film cooled component 100. That is, thermal gradients below about 200 F (93 C) yield acceptable stress levels with a minimal cooling flow.

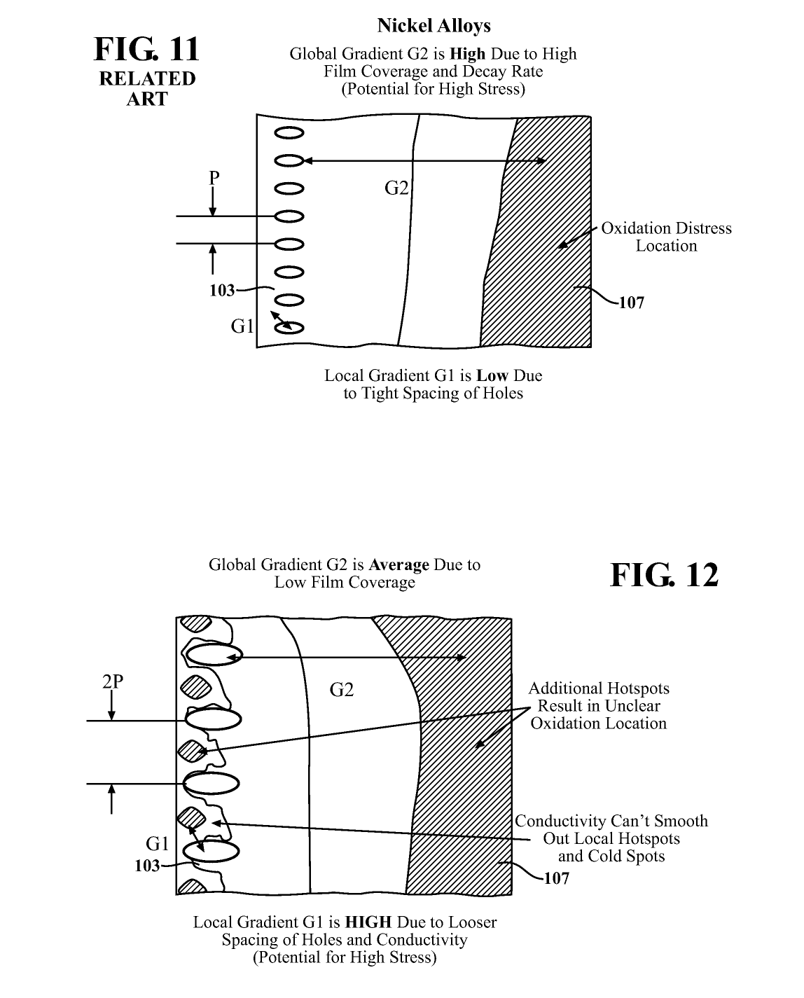

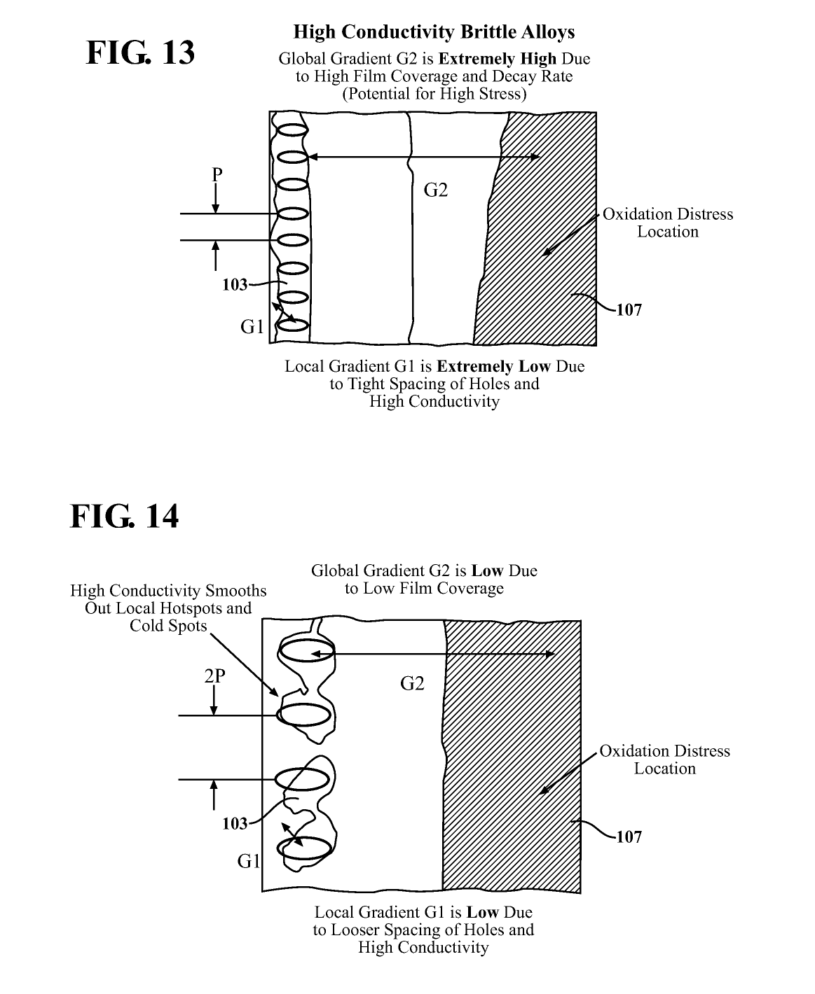

It should be appreciated that spacing the film holes 102 relatively farther apart reduces one thermal gradient but increases another thermal gradient. In Nickel alloys (FIGS. 11 and 12), the thermal gradient that drives the stress has the potential to switch from the global gradient G2 to the local gradient G1 (FIG. 12) as the film holes are spaced farther apart since the conductivity of Nickel alloys can not smooth out the local temps. Whereas, in High Conductivity materials (FIGS. 13 and 14), spacing the film holes 102 farther apart does not switch the primary driver of stress from the global gradient G2 to a local gradient G1 (FIG. 14).

The use of the terms “a,” “an,” “the,” and similar references in the context of description (especially in the context of the following claims) are to be construed to cover both the singular and the plural, unless otherwise indicated herein or specifically contradicted by context. The modifier “about” used in connection with a quantity is inclusive of the stated value and has the meaning dictated by the context (e.g., it includes the degree of error associated with measurement of the particular quantity). All ranges disclosed herein are inclusive of the endpoints, and the endpoints are independently combinable with each other.

Although the different non-limiting embodiments have specific illustrated components, the embodiments of this invention are not limited to those particular combinations. It is possible to use some of the components or features from any of the non-limiting embodiments in combination with features or components from any of the other non-limiting embodiments.

It should be appreciated that like reference numerals identify corresponding or similar elements throughout the several drawings. It should also be appreciated that although a particular component arrangement is disclosed in the illustrated embodiment, other arrangements will benefit herefrom.

Although particular step sequences are shown, described, and claimed, it should be understood that steps may be performed in any order, separated or combined unless otherwise indicated and will still benefit from the present disclosure.

The foregoing description is exemplary rather than defined by the limitations within. Various non-limiting embodiments are disclosed herein, however, one of ordinary skill in the art would recognize that various modifications and variations in light of the above teachings will fall within the scope of the appended claims. It is therefore to be understood that within the scope of the appended claims, the disclosure may be practiced other than as specifically described. For that reason the appended claims should be studied to determine true scope and content.

What is claimed:

1. A component for a gas turbine engine, comprising:
a highly conductive film cooled component with a leading edge area and a trailing edge area, including a multiple of film holes in a film hole region, each of said multiple of film holes spaced one to another to reduce a thermal gradient aft of said film hole region to below about 200 F (93 C).

2. The component as recited in claim 1, wherein said component is manufactured of Molybdenum.

3. The component as recited in claim 1, wherein said highly conductive film cooled component is manufactured of a Monolithic ceramic.

4. The component as recited in claim 1, wherein said leading edge area and said trailing edge area define a chord of a component.

5. The component as recited in claim 4, wherein said multiple of film holes are arranged in a row transverse to said chord.

6. The component as recited in claim 1, wherein said multiple of film holes provide a coverage of between about 15%-75%.

7. The component as recited in claim 6, wherein said multiple of film holes provide a coverage of between about 40%-60%.

8. The component as recited in claim 1, wherein said multiple of film holes provide a ligament distance greater than about 0.050 in (1.27 mm).

9. The component as recited in claim 1, wherein each of said multiple of film holes define a pitch to diameter (P/D) ratio greater than about 2.2.

10. The component as recited in claim 9, wherein each of said multiple of film holes define a pitch to diameter (P/D) ratio greater than about 4.

11. A component for a gas turbine engine, comprising:
a highly conductive film cooled component with a thermal conductivity greater than about 150 BTU (IT)-inch/hour/square foot/° F. and a row of multiple film holes that provide a coverage between about 15%-75%.

12. The component as recited in claim 11, wherein said multiple of film holes provide a coverage of between about 40%-60%.

13. The component as recited in claim 11, wherein said multiple of film holes provide a ligament distance greater than about 0.050 in (1.27 mm).

14. The component as recited in claim 13, wherein each of said multiple of film holes define a pitch to diameter (P/D) ratio greater than about 2.2.

15. The component as recited in claim 14, wherein each of said multiple of film holes define a pitch to diameter (P/D) ratio greater than about 4.

16. The component as recited in claim 14, wherein said multiple of film holes reduces a thermal gradient between a film hole region with said of multiple film holes and a trailing edge area aft thereof to below about 200 F (93 C).

17. A method of cooling a film cooled component for a gas turbine engine, comprising:
arranging at least one row of a multiple of film holes proximate a leading edge area of a highly conductive film cooled component to control a thermal gradient aft of said multiple of film holes such that a stress from the thermal gradient is below a predetermined acceptable stress.

18. The method as recited in claim 17, wherein the thermal gradient is below about 200 F (93 C).

19. The method as recited in claim 17, wherein the arranging further comprises providing a ligament distance between each of the multiple of film holes with respect to a thermal conductivity of a material of the highly conductive film cooled component.

20. The method as recited in claim 19, wherein the thermal conductivity of said material is at least about 300% that of a nickel superalloy.
